(19) United States
(12) Patent Application Publication
(10) Pub. No.: US 2018/0255356 A1
(43) Pub. Date: Sep. 6, 2018

(54) METHOD, SYSTEM AND DEVICE FOR POSTING VIDEO COMMENTS

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Yu ZHAO, BEIJING (CN)

(21) Appl. No.: 15/119,524

(22) PCT Filed: May 27, 2016
(86) PCT No.: PCT/CN2016/083727

§ 371 Date: Aug. 17, 2016

(30) Foreign Application Priority Data
Nov. 25, 2015 (CN) 201510836733.3

(51) Int. Cl. H04N 21/475; H04N 21/4788; G06F 3/0488; G06F 3/16

(52) U.S. Cl. CPC H04N 21/475; G06F 3/167; G06F 3/04886; H04N 21/4788

(57) ABSTRACT

Disclosed is a method, system and device for posting a video comment, comprising: sensing a first touch event during playback of a video file; determining a touch position of the first touch event; if the touch position is located within a comment reply area, continuing to sense a second touch event; displaying a posting interface corresponding to the second touch event; and obtaining the comment message input by user from the posting interface and posting the comment message as a comment on the video file. The present disclosure can propose a touch method based on the levels of pressure, and can be used to quickly and easily browse the comments on a video file, and post a new comment on the video file, so that the steps requested for posting and replying the video comments can be reduced and the usability, operability and fluency of video application can be improved.

### CROSS REFERENCE TO RELATED APPLICATIONS

This application is a continuation of International Application No. PCT/CN2016/083727, filed on May 27, 2016, which is based upon and claims priority to Chinese Patent Application No. 2015108367333, filed on Nov. 25, 2015, the entire contents of which are incorporated herein by reference.

### TECHNICAL FIELD

The present disclosure relates to multimedia control technology, and more particularly to a method, system and device for posting video comments.

### BACKGROUND

When a user watches a video by using the existing touch-control devices, if the user want to comment on the video, he/she usually needs to exit full-screen viewing mode and enter half-screen viewing mode (that is a display mode of the upper part of the screen as a video display area and the lower half of the screen as a comment display area); in the half-screen mode, the user needs multiple steps by clicks to post a comment. However, there are some general problems of complicated steps and adversely affecting the video watching fluency of the user in the prior methods for posting video comments.

Most of the existing touch-control devices have touch gestures function by which interface switching, parameter adjustment and other functions can be implemented by simple tapping, swiping, pinching gestures. But, in most of the video players, the tapping gesture is often used to play and pause, the swiping gesture is usually used to adjust the volume, brightness and video progress, and the pinching gesture is usually used for partial zoom. The other gestures are inconvenient to be applied in the video player due to more complexity and potential malfunctions.

### SUMMARY

In view of this, an object of an embodiment of the present disclosure is to provide a method, system and device for posting video comments, to simplify the operation steps for posting video comments and enhance the fluency when posting the video comments.

According to a first aspect of embodiments of the present disclosure, there is provided a method for posting video comments, includes:

sensing a first touch event during playback of a video file;

determining a touch position of the first touch event;

if the touch position is located within a comment reply area, continuing to sense a second touch event;

displaying a posting interface corresponding to the second touch event; and

obtaining a comment message input by a user from the posting interface and posting the comment message as a comment on the video file.

In some alternative embodiments, the step of displaying a posting interface corresponding to the second touch event further includes:

determining the type of the second touch event; and

if the second touch event is a light pressing, displaying a tab including a text posting interface and a voice posting interface; or

if the second touch event is a heavy pressing, directly entering the voice posting interface.

In some alternative embodiments, the step of if the second touch event is a light pressing displaying a tab including a text posting interface and a voice posting interface further includes:

sensing a fourth touch event;

determining the touch position of the fourth touch event; and

if the touch position of the fourth touch event is located within the display area of any one of the text posting interface or the voice posting interface, entering the corresponding interface.

In some alternative embodiments, the text posting interface includes a text input area and a trigger area, and after entering the text posting interface, the method further includes:

obtaining a text message input by the user and temporarily storing it in the text input area;

sensing a fifth touch event;

determining the touch position of the fifth touch event; and

if the touch position of the fifth touch event is located within the trigger area of the text posting interface, sending the text message temporally stored in the text input area as a reply message; and

wherein the voice posting interface includes a voice input area, and after entering the voice posting interface, the method further includes:

sensing a sixth touch event;

determining a touch position of the sixth touch event;

if the touch position of the sixth touch event is located within the voice input area of the voice posting interface, enabling a recording function;

if the touch disappears, stopping the recording function and generating an audio file; and

sending the audio file as a reply message.

In some alternative embodiments, the tab also includes a comment push interface, and after entering the comment push interface, the method further includes:

establishing a comment display window;

obtaining all comments of the video file;

extracting a number of comments with the maximum number of replies and labelling them as hot comments; and

displaying the hot comments in the comment display window.

In some alternative embodiments, after the step of determining the touch position of the first touch event, the method further includes:

if the touch position is located within a video playback area, continuing to sense a third touch event, wherein the video playback area is an area for displaying the now-playing video file;

if determining the third touch event is a light pressing, entering the text posting interface, wherein the text posting interface includes a text input area for temporarily storing a text message input by the user and a trigger area for sending the text message as a comment on the video file; or

if determining the third touch event is a heavy pressing, entering the voice posting interface, wherein the voice posting interface includes a voice input area for enabling and stopping an audio recording function and sending an audio file obtained by the audio recording function as a comment on the video file.

According to a second aspect of embodiments of the present disclosure, there is provided a system for posting a video comment, includes:

a display unit for displaying a video playback page;

a touch event detecting unit for sensing a touch event and determining the touch position of the touch event and the type of the touch event during the playback of a video file; and

a touch event processing unit for entering different touch event according to the respective touch position;

wherein during the playback of the video file, the touch event detecting unit is configured to sensing a first touch event and determining a touch position of the first touch event, and if the touch position is located within a comment reply area, continuing to sense a second touch event; and the touch event processing unit is configured to displaying the corresponding posting interface on the display unit in accordance with the second touch event, and obtaining a comment message input by a user from the posting interface, and posting the comment message as a comment on the video file.

In some alternative embodiments, the touch event detecting unit is configured to determining the type of the second touch event; if the second touch event is a light pressing, the touch event processing unit is further used for displaying a tab including a text posting interface and a voice posting interface on the display unit; if the second touch event is a heavy pressing, directly entering the voice posting interface.

In some alternative embodiments, the touch event detecting unit is configured to sensing a fourth touch event, and determining a touch position of the fourth touch event; if the touch position is located within a display area of any one of the text posting interface or the voice posting interface, the touch event processing unit is configured to entering the corresponding interface.

In some alternative embodiments, after entering the text posting interface, the touch event processing unit is further configured to obtaining a text message input by a user and temporarily storing it in the text input area; the touch event detecting unit is further configured to sensing a fifth touch event and determining the touch position of the fifth touch event; if the touch position is located within a trigger area of the text posting interface, the touch event processing unit is further configured to sending the text message temporarily stored in the text input area as a reply message;

after entering the voice posting interface, the touch event detecting unit is also configured to sensing a sixth touch event and determining the touch position of the sixth touch event; if the touch position is located within a voice input area of the voice posting interface, the touch event processing unit is also configured to enabling a voice recording function; if the touch disappears, stopping the voice recording function and generating an audio file; and the touch event processing unit is further configured to sending the audio file as a reply message.

In some alternative embodiments, the tab also includes a comment push interface, wherein the touch event processing unit is also configured to establishing a comment display window, obtaining all the comments of the video file, extracting a number of comments having the maximum number of replies from all comments and labelling them as hot comments, and displaying the hot comments in the comment display window.

In some alternative embodiments, if the touch position is located within the video playback area, the touch event detecting unit is further configured to continuing to sense a third touch event, wherein the video playback area is an area for displaying the now-playing video file; and

if the third touch event is determined as a light pressing, the touch event processing unit is further configured to entering the text posting interface, wherein the text posting interface includes a text input area for temporarily storing a text message input by the user and a trigger area for sending the text message as a comment on the video file; or
if the third touch event is determined as a heavy pressing, the touch event processing unit is further configured to entering the voice posting interface, wherein the voice posting interface includes a voice input area for enabling and stopping a recording function and for sending an audio file obtained by the recording function as a comment on the video file.

The third aspect of the embodiments of the present disclosure further provides a device, includes:

a display unit for receiving a touch signal and displaying a video image;

one or more processors; and

a memory for storing an operating instruction;

wherein the one or more processors are configured to acquiring the operating instruction from the memory and execute the following of:

sensing a first touch event of the display unit during the playback of a video file;

determining a touch position of the first touch event;

if the touch position is located within a comment reply area, continuing to sense a second touch event of the display unit;

displaying a posting interface corresponding to the second touch event; and

obtaining a comment message input by a user from the posting interface and posting the comment message as a comment on the video file.

In some alternative embodiments, the processor is further configured to execute the following of:

determining the type of the second touch event; and

if the second touch event is a light pressing, displaying a tab including a text posting interface and a voice posting interface; or

if the second touch event is a heavy pressing, directly entering the voice posting interface.

In some alternative embodiments, the processor is further configured to execute the following of:

sensing a fourth touch event;

determining a touch position of the fourth touch event; and

if the touch position is located within a display area of any one of the text posting interface or the voice posting interface, entering the corresponding interface.

In some alternative embodiments, the text posting interface includes a text input area and a trigger area, wherein the processor is further configured to execute the following of:

obtaining a text message input by the user and temporarily storing it in the text input area;

sensing a fifth touch event;

determining a touch position of the fifth touch event;

if the touch position is located within the trigger area of the text posting interface, sending the text message temporarily stored in the text input area as a reply message; and

the voice posting interface includes a voice input area; and after entering the voice posting interface, the processor is further configured to executing the steps of:

sensing a sixth touch event;

determining the touch position of the sixth touch event;

if the touch position is located within the voice input area of the voice posting interface, enabling a recording function;

if the touch disappears, stopping the recording function and generating an audio file; and

sending the audio file as a reply message.

In some alternative embodiments, the tab also includes a comment push interface, wherein the processor is further configured to execute the following of:

establishing a comment message display window;

obtaining all comments of a video file;

extracting a number of comments having the maximum number of replies from all the comments and labelling them as hot comments; and

displaying the hot comments in the comment display window.

In some alternative embodiments, the processor is further configured to execute the following of:

if the touch position is located within the video playback area, continuing to sense a third touch event, wherein the video playback area is an area for displaying the now-playing video file; and

if the third touch event is determined as a light pressing, entering the text posting interface, wherein the text posting interface includes a text input area for temporarily storing a text message input by the user and a trigger area for sending the text message as a comment on the video file; or

if the third touch event is determined as a heavy pressing, entering the voice posting interface, wherein the voice posting interface includes a voice input area for enabling or stopping an audio recording function and for sending an audio file obtained by the audio recording function as a comment on the video file.

As can be seen from the above, a method, system and device for posting video comments provided by the embodiments of the present disclosure can propose a touch method based on the levels of pressure, and can be used for the user to quickly and easily browse the comments on a video file, reply to the comments, and post a new comment on the video file, so that the operating steps requested for the user posting and replying the video comments can be reduced and the usability, operability and fluency of the video application can be improved.

### BRIEF DESCRIPTION OF DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flow diagram of a method for posting video comment according to an embodiment of the present disclosure;

FIG. 2 is of schematic flow diagram of a method for posting video comment according to another embodiment of the present disclosure;

FIG. 3 is a module schematic view of a system for posting video comment according to the present disclosure.

### DETAILED DESCRIPTION

The present disclosure is described more fully hereinafter with reference to the accompanying drawings so that the objects, technical solutions and advantages of the present invention will become more apparent.

It will be understood that, the terms “first”, “second” etc. used herein is to distinguish various elements or parameters with the same name for the convenience. The embodiments of the present invention should not be limited by these terms and the specific description of these terms for the embodiments would be omitted hereinafter.

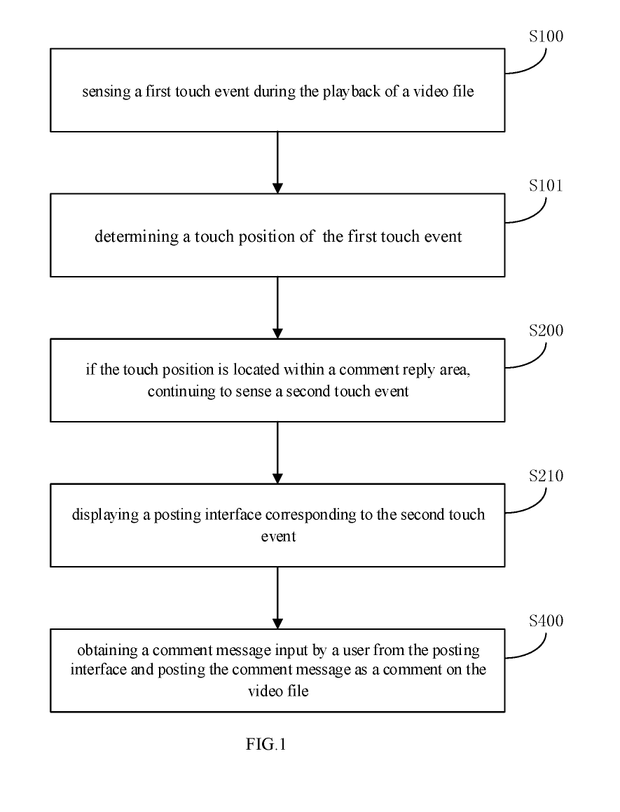

FIG. 1 is a schematic flow diagram of a method for posting video comment according to an embodiment of the present disclosure. With reference to FIG. 1, a method for posting video comment according to an embodiment of the present disclosure includes:

S100, sensing a first touch event during the playback of a video file;

S101, determining a touch position of the first touch event;

S200, if the touch position is located within a comment reply area, continuing to sense a second touch event, wherein the comment reply area refers to a display area where the user comments on the video file;

The term “comment” used herein does not only comprise the comment on video file, but also comprise the reply messages to the comment by other users. In this embodiment, the comment reply area means to an area with a list of comments on the video file by other users.

In the half-screen playback mode, the comment reply area is mostly provided in the lower half of the screen in which the user's comments are provided one by one. In the prior art, the user can reply to a specific comment by clicking on the buttons marked with “Reply” “Send”, etc. beside the comment; or the user can open a comment window to comment by clicking on each user's comment.

Alternatively, in full-screen playback mode, the comment reply area also can be provided in somewhere of the video playback window (such as the side or the bottom thereof). While the video file is normally playing, the comment reply area is hidden and when the comments are needed to be reviewed, the comment reply area can be directly displayed on the video playback window by the user clicking on the comment reply area to complete the review and reply to the comments.

S210, displaying a posting interface corresponding to the second touch event. The posting interface refers to a interface providing windows, buttons, etc., for user to input and post a comment message and a backend message transmitting link. The particular forms thereof will be described thereinafter;

S400, obtaining the comment message input by user from the posting interface and sending the comment message as a comment on the video file. Further, in an embodiment, the step S210 of displaying a posting interface corresponding to the second touch event further includes:

S211, determining the type of the second touch event;

S212, if the second touch event is a light pressing, displaying a tab including a text posting interface and a voice posting interface;

S213, if the second touch event is a heavy pressing, directly entering the voice posting interface.

In this embodiment, the target of the text posting interface and the voice posting interface is the comment on video and the sending message as the reply to the comment. The text posting interface is used for replying text message as a reply to the comments on video and the voice posting interface is used for replying a voice message as a reply to the comments on video. In particular, the touch position of the tap signal is further determined and the comment item located by the touch position becomes the target of the text posting interface and the voice posting interface.

The text posting interface and the voice posting interface are a reply interface easier to be accepted and commonly used by current users. In fact, other reply interfaces with other reply forms also can be added in the tab, or the text posting interface and the voice posting interface can be replaced by the other reply interfaces with other reply forms, or the other interfaces than the reply interfaces such as sharing interface, favorites interface, etc., can be added.

The term “light pressing” and “heavy pressing” used herein refers to when a finger touches a screen to impose a certain pressure for a period of time, the touch with less pressure is light pressing and that with heavier pressure is heavy pressing.

The alternative means to distinguish the pressure of light pressing and heavy pressing can be:

measuring the touch pressure by using a touch screen having a pressure sensitive measurement function and judging the touch event is light pressing or heavy pressing by comparing the touch pressure with a default first pressure threshold, that is, the touch pressure greater than the first pressure threshold is determined as a heavy pressing and that less than or equal to the first pressure threshold is determined as a light pressing; or

monitoring the touch area (herein merely for finger) by using a touch screen which is able to measure the touch area, wherein during the first touch event occurs, if the contact area between the finger and the touch screen is smaller than the default first touch area threshold, it is determined as a light pressing, and if the contact area between the finger and the touch screen is larger than the default first touch area threshold, it is determined as a heavy pressing; or

combining the pressure with the touch area to judge, for example, if the touch pressure is less than the first pressure threshold and/or the touch area is smaller than the first touch area threshold, it is determined as a light pressing, and if the touch pressure is more than the first pressure threshold and/or the touch area is larger than the first touch area threshold, it is determined as a heavy pressing.

The above-mentioned means to distinguish between light pressing and heavy pressing also can be implemented by the current terminal devices having 3D Touch Technology, such as iPhone 6S, iPhone 6S plus, iPad pro and future devices having IOS9.0 and above operating system.

This embodiment achieves the processes of when the user is watching a video in full-screen mode, if he/she wants to review the comments on the video file from other users, he/she can click on a predetermined area in the video playback window to emerge a comment reply area and trigger a tab comprising a plurality of optional reply interfaces by further tapping a comment item; or the user also can switch to half-screen mode and browse video comments in a conventional way of slide operations, and can trigger a tab comprising a plurality of optional reply interfaces by further tapping a comment item.

If the user applies a heavy press on a comment item, he can enter the text posting interface or the voice posting interface directly, without selecting from the tab by tapping and triggering the tab, so as to further simplify the steps to post a reply. The specific interface accessible can be predetermined by the program, or customized by providing options for the user.

Further, in an alternative embodiment, the step of S211 of if the second touch event is a light pressing displaying a tab comprising a text posting interface and a voice posting interface further includes:

S2111, obtaining a fourth touch event;

S2112, determining a touch position of the fourth touch event;

S2113, if the touch position of the fourth touch event is located within a display area of any one of the text posting interface or the voice posting interface, entering the corresponding interface.

Further, in a specific embodiment, the text posting interface includes a text input area and a trigger area, and after entering the text posting interface, the method further includes:

S411, obtaining a text message input by user and temporarily storing it in the text input area;

S412, sensing a fifth touch event;

S413, determining the touch position of the fifth touch event;

S414, if the touch position of the fifth touch event is located within the trigger area of the text posting interface, sending the text message temporarily stored in the text input area as a reply message.

Further, the voice posting interface includes a voice input area and after entering the voice posting interface, the method further includes:

S421, sensing a sixth touch event;

S422, determining the touch position of the sixth touch event;

S423, if the touch position of the sixth touch event is located within the voice input area of the voice posting interface, enabling the voice recording function;

S424, if the touch disappears, stopping the recording function and generating an audio file;

S425, sending the audio file as a reply message.

Through the above steps, the user can send the input text as a reply to one comment or send the input voice as a reply to one comment.

In some alternative embodiments, the tab also includes a comment push interface, and after entering the comment push interface, the method further includes:

S431, establishing a comment message display window;

S432, obtaining all the comments of the video file, in particular, wherein the comments denied by the services due to report by users or failed to pass the review of backend staff or the comments unavailable for other reasons cannot be obtained;

S433, extracting a number of comments having a maximum number of replies from all the comments and labelling them as hot comments, wherein the messages with reply numbers more than a certain threshold can be extracted, or when the reply number of all the comments are ranked from more to less, a number of top-ranking messages can be extracted; and the extraction method is more flexible and can be set as required overall;

S434, displaying the hot comments in the comment display window.

The above steps S431-S434 provide users with a function of quick review of the hot comments on the video. The difference with the prior function for displaying hot comments is that the users in this embodiment do not need to find a specific button such as “hot comments”, etc. by page up or down, so that a quick and ubiquitous review can be achieved during the comments are reviewed by user.

It should be noted that the specific steps of entering the comment push interface can refer to the step S211 of entering any one of the text posting interface or the voice posting interface of the embodiment.

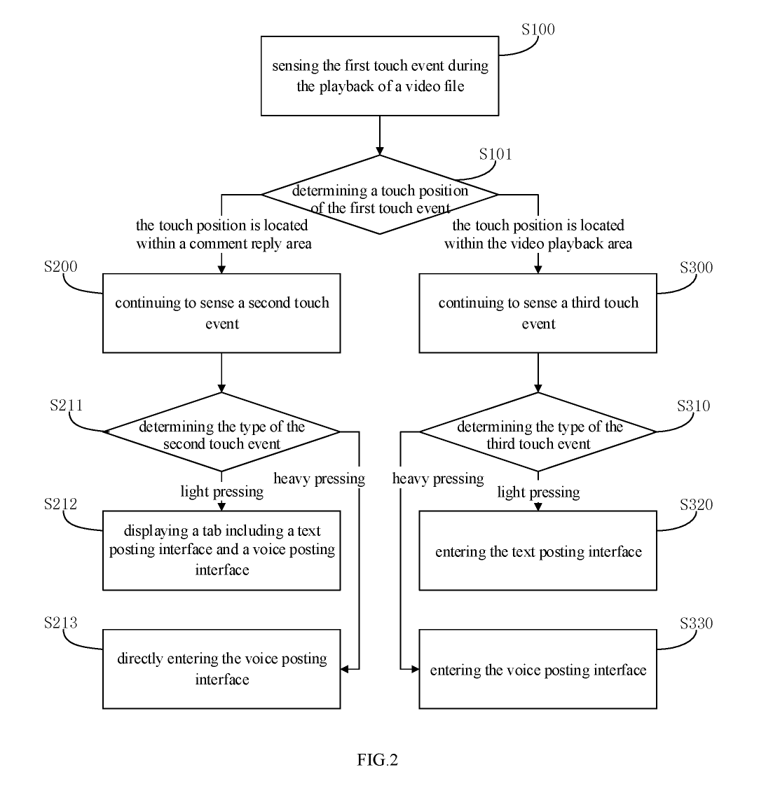

FIG. 2 is a schematic of flow diagram of a method for posting video comment according to another embodiment of the present disclosure. As shown, in an embodiment, in step S200, if the touch position is located within a comment reply area, continuing to sense the second touch event, further includes:

S300, if the touch position is located within the video playback area, continuing to sense a third touch event, wherein the video playback area is an area for display a now-playing video file.

It should be noted that if an area for triggering other gesture function (for example, an advertising display area or the comment display area disclosed in the above embodiments, etc.) is provided in the video playback area, prioritizing the other gestures function, but the third touch event only being processed when the user touches a blank area without setting any specific operation;

S310, determining the type of the third touch event;

S320, if the third touch event is a light pressing, directly entering the text posting interface, wherein the text posting interface includes a text input area for temporarily storing a text message input by user and a trigger area for sending the text message as a comment on the video file;

S330, if the third touch event is a heavy pressing, entering the voice posting interface, wherein the voice posting interface includes a voice input area for enabling or stopping the audio recording function and sending the audio file obtained by the audio recording function as a comment on the video file.

The text posting interface and the voice posting interface in the steps S320 and S330 have a difference from these disclosed in the aforementioned embodiment in that the target of the posting interfaces in the steps of S320 and S330 is the video file, that is, the messages sent by the interfaces are posted as the comments on the video file, not the replies to a specific comment message.

As can be seen, by the execution of steps S310-S330, the user can enter the text posting interface by tapping in the blank of the playback interface at the mode of full-screen playback of video file without exiting the full-screen playback mode. The video playback interface can display a comment window provided with an input box (text input area) and a posting button marked with “send”, “comment” and other words, and the user can further comment on the video file with a text message. Alternatively, the user can also enter the voice posting interface by pressing in the blank of the playback interface at the mode of full-screen playback of video file without exiting the full-screen playback mode. The video playback interface can display a comment window provided with a recoding button (voice input area) marked with “press to record” and other words, and the user can further comment on the video file with a voice message. The steps S310-S330 can save the step of quitting to the half-screen mode, which can simplify the operation process and improve the speed of users to post the video comments.

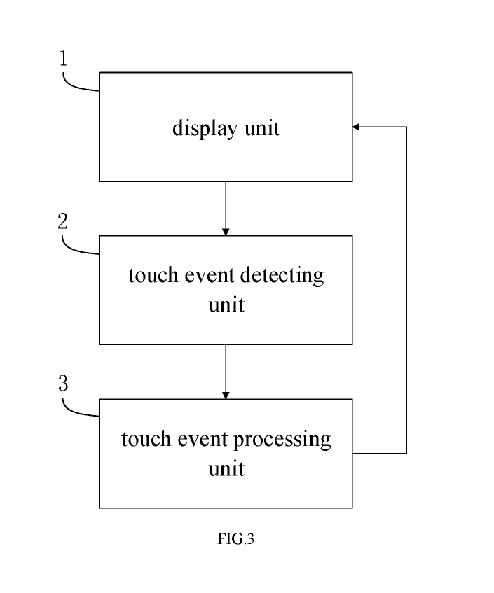

The present disclosure also discloses a system for posting video comment. FIG. 3 is a block diagram of the system. As shown, the system includes:

a display unit 1 for displaying a video file playback page;

a touch event detecting unit 2 for sensing a touch event during the video file be playing and determining a touch position of the touch event and the type of the touch event; and

a touch event processing unit 3 for entering the different touch event according to the touch position;

wherein during the playback of the video file, the touch event detecting unit 2 being configured to sensing the first touch event to determine the touch position of the first touch event, and if the touch position is located within a comment reply area, continuing to sense the second touch event; the touch event processing unit 2 is configured to displaying the corresponding posting interface on the display unit in accordance with the second touch event; obtaining the comment information input by user from the posting interface, and posting the comment message as a comment on a video file.

In some alternative embodiments, the touch event detecting unit 2 is configured to determining the type of the second touch event. If the second touch event is a light pressing, the touch event processing unit 3 is further used to display a tab including a text posting interface and a voice posting interface on the display unit 1; and if the second touch event is a heavy pressing, directly entering the voice posting interface.

In some alternative embodiments, the touch event detecting unit 2 is configured to sensing a fourth event, and determining the touch position of the fourth touch event. If the touch position is located within a display area of any one of the text posting interface and a voice posting interface, the touch event processing unit enters the corresponding interface.

In some alternative embodiments, after entering the text posting interface, the touch event processing unit 3 is further used to obtain the text message input by user that temporarily stored in the text input area; the touch event detecting unit 2 is further used to sense a fifth touch event and determine the touch position of the fifth touch event; if the touch position is located within a trigger area of the text posting interface, the touch event processing unit 3 is further used to send the text message temporarily stored in the text input area as a reply message.

After entering the voice posting interface, the touch event detecting unit 2 is further configured to sensing a sixth touch event; determining the touch position of the sixth touch event; if the touch position is located within a voice input area of the voice posting interface, the touch event processing unit 3 is also configured to enabling the voice recording function; if the touch disappears, stopping the voice recording function to generate an audio file; and the touch event processing unit 3 is further configured to sending the audio file as a reply message.

In some alternative embodiments, the tab also includes a comment push interface, wherein the touch event processing unit 3 is also configured to establishing a comment display window, obtaining all the comments of a video file, extracting a portion of comments having the largest number of replies from all comments which is marked as top comments, and displaying the top comments on the comment display window.

In some alternative embodiments, if the touch position is located within the video playback area, the touch event detecting unit is further configured to continuing to sense the third touch event, wherein the video playback area is the area configured to displaying the now playing video file.

If the third touch event is determined as a light pressing, the touch event processing unit 3 is further configured to entering the text posting interface, wherein the text posting interface includes a text input area for temporarily storing the text input by user and a trigger area for sending the text as a comment on the video file.

If the third touch event is determined as a heavy pressing, the touch event processing unit 3 is further configured to entering the voice posting interface, wherein the voice posting interface comprising a voice recording area for enabling and stopping the recording function and for sending the audio file obtained by the recording function as a comment on the video file.

Embodiments of the present disclosure also provides an electronic device, includes:

a display unit for receiving a touch signal and displaying a video image;

one or more processors; and

a memory for storing an operating instruction.

The one or more processors are configured to obtain the operating instruction from the memory and to execute the steps of:

sensing the first touch event of the display unit during playback of a video file;

determining the touch position of the first touch event;

if the touch position is located within a comment reply area, keep up sensing the second touch event of the display unit;

displaying a posting interface corresponding to the second touch event; and

obtaining a comment message input by user from the posting interface and posting the comment message as a comment on the video file.

In some alternative embodiments, the processor is further configured to execute the steps of:

determining the type of the second touch event;

if the second touch event is a light pressing, displaying a tab including a text posting interface and a voice posting interface; and

if the second touch event is a heavy pressing, directly entering the voice posting interface.

In some alternative embodiments, the processor is further configured to execute the steps of:

sensing a fourth touch event;

determining the touch position of the fourth touch event; and

if the touch position is located within the display area of any one of the text posting interface or the voice posting interface, entering the interface.

In some alternative embodiments, the text posting interface includes a text input area and a trigger area, wherein the processor is further configured to execute the steps of:

obtaining a text message input by user and temporarily storing it in the text input area;

sensing a fifth touch event;

determining the touch position of the fifth touch event;

if the touch position is located within the trigger area of the text posting interface, sending the text message temporarily stored in the text input area as a reply message.

In some alternative embodiments, the voice posting interface includes a voice recording area, and once entering the voice posting interface, the processor is further used for execute the steps of:

sensing a sixth touch event;

determining the touch position of the sixth touch event;

if the touch position is located within the voice recording area of the voice posting interface, enabling the recording function;

if the touch disappears, stopping the recording function to generate an audio file; and

sending the audio file as a reply message.

In some alternative embodiments, the tab also includes a comment push interface, wherein the processor is further configured to execute the steps of:

establishing a comment message display window;

obtaining all comments of a video file;

extracting some comments having the largest number of replies from all the comments to be marked as top comments; and

displaying the top comments in the comment display window.

In some alternative embodiments, the processor is further configured to execute the steps of:

if the touch position is located within the video play area, continuing to sense the third touch event, wherein the video play area is an area for displaying the now playing video file;

if the third touch event is determined as a light pressing, entering the text posting interface, wherein the text posting interface includes a text input area for temporarily storing a text message input by user and a trigger area for sending the text message as a comment on the video file;

if the third touch event is determined as a heavy pressing, entering the voice posting interface, wherein the voice posting interface includes a voice input area for enabling or stopping the audio recording function and for sending an audio file obtained by the audio recording function as a comment on the video file.

In summary, a method, system and device for posting video comments provided by the embodiments of the present disclosure propose a touch method based on the levels of pressing force, and can be used by the users to quickly and easily browse the comments on a video file, reply to the comment, and post a new comment on the video file, so that the operating steps requested for the user posting and replying the video comments can be reduced and the easy-of-use, operability and fluency of video application can be improved.

In addition, typically, the device of the present disclosure can be a variety of electronic terminal devices such as mobile phone, personal digital assistant (PDA), tablet PC (PAD), smart TV, etc., so that the scope of the disclosure should not be limited to a specific type of electronic device. The system of the present disclosure can be applied in any one of the above electronic terminal device in the form of electronic hardware, computer software or a combination thereof.

Furthermore, the method according to the present disclosure may also be implemented as a computer program executed by CPU, and the computer program may be stored in a computer-readable storage medium. When the computer program is executed by CPU, the above functions defined in the methods of the present disclosure are executed.

Furthermore, the above-described method steps and system units can also be implemented by using a controller and a computer-readable storage medium for storing a computer program to make the controller to achieve the above steps or unit functions.

Additionally, it should be appreciated that the computer-readable storage medium as described herein (for example, memory) may be volatile memory or nonvolatile memory, or can include both volatile memory and nonvolatile memory. As an example without any limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM) which can act as external cache RAM memory. As an example without any limitation, RAM is available in many forms, such as synchronous RAM (DRAM), dynamic RAM (DRAM), synchronous DRAM (SDRAM), double data rate SDRAM (DDR SDRAM), enhanced SDRAM (ESDRAM), sync link DRAM (SLDRAIVI) and direct rambusRAM (DRRAM). The disclosed aspects of the storage devices are intended to include, but not limited to these and other suitable types of memory.

Those skilled in the art will also understand that a combination of the illustrative logical blocks, modules, circuits, and algorithm steps described in this disclosure may be implemented as electronic hardware, computer software, or both. To clearly illustrate the interchangeability between hardware and software, various illustrative components, blocks, modules, circuits, and functions of steps have been generally described. Whether such function is implemented as software or hardware is depended on the particular application and the design constraints imposed on the whole system. Those skilled in the art can achieve the functions for each particular application in various ways, but such implementing decisions should not be interpreted as a departure from the scope of the present disclosure.

A combination of the illustrative logical blocks, modules, and circuits can be implemented or executed by using the following components designed to perform the functions described herein: general purpose processor (GPP), digital signal processor (DSP), dedicated integrated circuit (ASIC), field programmable gate array (FPGA) or other programmable logic device, discrete gate or transistor logic, discrete hardware components or any combination thereof. The GPP may be a microprocessor, but in the alternative, the processor may be any conventional processor, controller, microcontroller, or state machine. The processor may also be implemented as a combination of computing devices, e.g., a combination of DSP and microprocessor, a plurality of microprocessors, one or more microprocessors with a DSP core, or any other such configuration.

A combination of the steps of method or algorithm described herein may be contained directly in hardware, software module executed by a processor, or both. The software module may reside in RAM memory, flash memory, ROM memory, EPROM memory, EEPROM memory, registers, hard disk, removable disk, CD-ROM known in the art or any other form of storage medium. An exemplary storage medium is coupled to the processor such that the processor can read information from the storage medium or write information to the storage medium. Alternatively, the storage medium may be integrated into the processor. The processor and the storage medium may reside in ASIC. ASIC may reside in a user terminal. In one alternative, the processor and the storage medium may reside as discrete components in a user terminal.

In one or more exemplary designs, the functions described herein may be implemented in hardware, software, firmware, or any combination thereof. If implemented in software, the functions may be transmitted as one or more instructions or codes stored on a computer readable medium or by a computer-readable medium. Computer-readable medium includes both computer storage medium and communication medium, and the communication medium includes any medium contributed to transmit a computer program from one place to another. The storage medium may be any available medium accessible by a general purpose or special purpose computer. As an example without any restriction, the computer-readable medium can include RAM, ROM, EEPROM, CD-ROM or other optical disk storage, magnetic disk storage or other magnetic storage devices, or can be any other medium for carrying or storing the desired program codes in the form of instruction or data structures and can be accessed by or via a general purpose or special purpose computer. Also, any connection can be properly termed as a computer-readable medium. For example, if using a coaxial cable, fiber optic cable, twisted pair, digital subscriber line (DSL) or wireless technologies such as infrared, radio, and microwave to transmit software from website, server, or other remote source, the coaxial cable, fiber optic cable, twisted pair, DSL, or wireless technologies such as infrared, radio, and microwave are included in the definition of medium. As used herein, the terms of disk and disc include CD-ROM disc (CD), laser disc, optical disc, digital versatile disc (DVD), floppy disk and Blu-ray disc where the disk usually reproduces data magnetically and the disc reproduces data optically with lasers. Combinations of the above should also be included within the scope of computer-readable medium.

It should be understood that various changes and modifications may be made to the exemplary embodiments disclosed herein, without departing from the scopes of the disclosure defined in the appended claims. The functions, steps and/or actions of the method claims disclosed herein do not have to be executed in any particular order. Furthermore, although elements of the present disclosure may be described or claimed as an individual form, but a plurality can also be envisaged unless explicitly restricted to single.

It should be understood that, as used herein, unless the context clearly supports exceptions, the singular forms “a” (“a”, “an”, “the”) is intended to include the plural forms. It should also be understood that “and/or” used herein is intended to include any and all possible combinations of one or more of the associated listed items.

The serial number of the embodiments herein is merely used for illustration without representing the merits of the embodiments.

Those ordinary skilled in the art will appreciate that all or part of the steps to achieve the above-described embodiments may be accomplished by hardware or by instructing relevant hardware via program, and the program may be stored in a computer readable storage medium such as read-only memory, magnetic disk or optical disc.

Those ordinary skilled in the art will appreciate that any of the embodiments discussed are exemplary only without intended to imply that the scopes of the present disclosure (including claims) are limited to these examples; the embodiments or the features in the different embodiments may be combined and the steps may be implemented in any order in accordance with the idea of the present disclosure, and there are many other variations of the different aspects of the present disclosure as described herein without description in the details for simplicity. Thus, any omissions, modifications, equivalent replacements and improvements made in the spirit and principles of the present disclosure should be included within the scopes of the present disclosure.

What is claimed is:

1. A method for posting video comments, comprising:
sensing a first touch event during playback of a video file;
determining a touch position of the first touch event;
if the touch position is located within a comment reply area, continuing to sense a second touch event;
displaying a posting interface corresponding to the second touch event; and
obtaining a comment message input by a user from the posting interface and posting the comment message as a comment on the video file.

2. The method according to claim 1, wherein the step of displaying a posting interface corresponding to the second touch event further comprises:
determining the type of the second touch event; and
displaying a tab comprising a text posting interface and a voice posting interface if the second touch event is a light pressing; or
if the second touch event is a heavy pressing, directly entering the voice posting interface.

3. The method according to claim 2, wherein the step of displaying a tab comprising a text posting interface and a voice posting interface if the second touch event is a light pressing further comprises:
sensing a fourth touch event;
determining a touch position of the fourth touch event; and
if the touch position of the fourth touch event is located within a display area of any one of the text posting interface and the voice posting interface, entering the corresponding interface.

4. The method according to claim 3, wherein the text posting interface comprises a text input area and a trigger area, and after entering the text posting interface, the method further comprises:
obtaining a text message input by the user and temporarily storing it in the text input area;
sensing a fifth touch event;
determining the touch position of the fifth touch event; and
if the touch position of the fifth touch event is located within the trigger area of the text posting interface, sending the text message temporally stored in the text input area as a reply message; and
wherein the voice posting interface comprises a voice input area, and after entering the voice posting interface, the method further comprises the steps of:
sensing a sixth touch event;
determining a touch position of the sixth touch event;
if the touch position of the sixth touch event is located within the voice input area of the voice posting interface, enabling a recording function;
if the touch disappears, stopping the recording function and generating an audio file; and
sending the audio file as a reply message.

5. The method according to claim 2, wherein the tab also comprises a comment push interface, and after entering the comment push interface, the method further comprises:
establishing a comment display window;
obtaining all of comments of the video file;
extracting comments with the maximum number of replies from all of comments and labelling them as hot comments; and
displaying the hot comments in the comment display window.

6. The method according to claim 1, wherein after the step of determining the touch position of the first touch event, the method further comprises:
if the touch position is located within a video playback area, continuing to sense a third touch event, wherein the video playback area is an area for displaying the now-playing video file;
if determining the third touch event is a light pressing, entering the text posting interface, wherein the text posting interface includes a text input area for temporarily storing a text message input by the user and a trigger area for sending the text message as a comment on the video file; or
if determining the third touch event is a pressing, entering the voice posting interface, wherein the voice posting interface includes a voice input area for enabling and stopping an audio recording function and sending an audio file obtained by the audio recording function as a comment on the video file.

7. A system for posting video comments, comprising:
a display unit for displaying a video playback page;
a touch event detecting unit for sensing a touch event during the playback of a video file and determining a touch position of the touch event and the type of the touch event; and
a touch event processing unit for processing different touch event according to the respective touch position;
wherein during the playback of the video file, the touch event detecting unit is configured to sensing a first touch event and determining a touch position of the first touch event, and if the touch position is located within a comment reply area, continuing to sense a second touch event;
and the touch event processing unit is configured to displaying the corresponding posting interface on the display unit in accordance with the second touch event, and obtaining a comment message input by a user from the posting interface, and posting the comment message as a comment on the video file.

8. The system according to claim 7, wherein the touch event detecting unit is configured to determining the type of the second touch event; if the second touch event is a light pressing, the touch event processing unit is further configured to displaying a tab including a text posting interface and a voice posting interface on the display unit; if the second touch event is a heavy pressing, directly entering into the voice posting interface.

9. The system according to claim 8, wherein the touch event detecting unit is configured to sensing a fourth touch event, and determining a touch position of the fourth touch event; if the touch position is located within a display area of any one of the text posting interface or the voice posting interface, the touch event processing unit is configured to entering the corresponding interface.

10. The system according to claim 9, wherein after entering the text posting interface, the touch event processing unit is further configured to obtaining a text message input by the user and temporarily storing it in the text input area; the touch event detecting unit is further configured to sensing a fifth touch event and determining a touch position of the fifth touch event; if the touch position is located within a trigger area of the text posting interface, the touch event processing unit is further configured to sending the text message temporarily stored in the text input area as a reply message; or
after entering the voice posting interface, the touch event detecting unit is also configured to sensing a sixth touch event and determine a touch position of the sixth touch event; if the touch position is located within a voice input area of the voice posting interface, the touch event processing unit is also configured to enabling a voice recording function; if the touch disappears, stopping the voice recording function and generating an audio files; and the touch event processing unit is further configured to sending the audio file as a reply message.

11. The system according to claim 8, wherein the tab also includes a comment push interface, wherein the touch event processing unit is also configured to establishing a comment display window, obtaining all the comments of a video file, extracting a number of comments having the maximum number of replies from all comments and labelling them as top comments, and displaying the top comments in the comment display window.

12. The system according to claim 7, wherein if the touch position is located within the video playback area, the touch event detecting unit is further configured to continuing to sense a third touch event, wherein the video playback area is an area for displaying the now-playing video file; and
if the third touch event is determined as a light pressing, the touch event processing unit is further configured to entering the text posting interface, wherein the text posting interface includes a text input area for temporarily storing a text message input by the user and a trigger area for sending the text message as a comment on the video file; or
if the third touch event is determined as a heavy pressing, the touch event processing unit is further configured to entering the voice posting interface, wherein the voice posting interface includes a voice recording area for enabling and stopping a recording function and for sending an audio file obtained by the recording function as a comment on the video file.

13. An electronic device, comprising:
a display unit for receiving a touch signal and displaying a video image;
one or more processors; and
a memory for storing an operating instruction;
wherein the one or more processors are configured to acquire the operating instruction from the memory and execute the following of:
sensing a first touch event of the display unit during the playback of a video file;
determining a touch position of the first touch event;
if the touch position is located within a comment reply area, continuing to sense a second touch event of the display unit;
displaying a posting interface corresponding to the second touch event; and
obtaining a comment message input by a user from the posting interface and posting the comment message as a comment on the video file.

14. The electronic device according to claim 13, wherein the processor is further configured to execute the following of:
determining the type of the second touch event; and
if the second touch event is a light pressing, displaying a tab including a text posting interface and a voice posting interface; or
if the second touch event is a pressing, directly entering the voice posting interface.

15. The electronic device according to claim 14, wherein the processor is further configured to execute the following of:
sensing a fourth touch event;
determining a touch position of the fourth touch event; and
if the touch position is located within a display area of any one of the text posting interface and the voice posting interface, entering the corresponding interface.

16. The electronic device according to claim 15, wherein the text posting interface includes a text input area and a trigger area, and the processor is further configured to execute the following of:
obtaining a text message input by the user and temporarily storing it in the text input area;
sensing a fifth touch event;
determining a touch position of the fifth touch event;
if the touch position is located within the trigger area of the text posting interface, sending the text message temporarily stored in the text input area as a reply message; and
wherein the voice posting interface includes a voice input area, and after entering the voice posting interface, the processor is further configured to executing the steps of:
sensing a sixth touch event;
determining a touch position of the sixth touch event;
if the touch position is located within the voice input area of the voice posting interface, enabling an audio recording function;
if the touch disappears, stopping the recording function and generating an audio file; and
sending the audio file as a reply message.

17. The electronic device according to claim 14, wherein the tab also includes a comment push interface, and the processor is further configured to execute the following of:
establishing a comment message display window;
obtaining all comments of a video file;
extracting a number of comments having the maximum number of replies from all the comments and labelling them as top comments; and
displaying the top comments in the comment display window.

18. The electronic device according to claim 13, wherein the processor is further configured to execute the following of:
if the touch position is located within the video playback area, continuing to sense a third touch event, wherein the video playback area is an area for displaying the now-playing video file;
if the third touch event is determined as a light pressing, entering the text posting interface, wherein the text posting interface includes a text input area for temporarily storing a text message input by the user and a trigger area for sending the text message as a comment on the video file; or
if the third touch event is determined as a pressing, entering into the voice posting interface, wherein the voice posting interface includes a voice input area for enabling or stopping an audio recording function and for sending an audio file obtained by the audio recording function as a comment on the video file.
